(19) United States
(12) Patent Application Publication
(10) Pub. No.: US 2010/0246555 A1
(43) Pub. Date: Sep. 30, 2010

(54) SIMPLE BASE STATION CAPABLE OF COUPLING TO A MOBILE COMMUNICATION NETWORK VIA A TELEPHONE CABLE

(76) Inventor: Jing ZHANG, Xi'an (CN)

Correspondence Address: Muncy, Geissler, Olds & Lowe, PLLC, 4000 Legato Road, Suite 310, FAIRFAX, VA, 22033, US

(21) Appl. No.: 12/651,222

(22) Filed: Dec. 31, 2009

(30) Foreign Application Priority Data
Mar. 27, 2009 (TW) 098110086

(51) Int. Cl. H04J 1/00; H04B 1/38; H04J 3/00

(52) U.S. Cl. 370/343; 455/561; 370/345

(57) ABSTRACT

A simple base station for coupling to a mobile communication network via a telephone cable, includes an antenna module for receiving and transmitting a plurality of frequency signals; a transmission control module setting up a plurality communication channels respectively corresponding to the frequency signals; a converting module coupled electrically to the transmission control module for converting a respective one of the frequency signals within a respective one of the communication channels into a packet; and a modem having a first end coupled electrically to the Internet via the telephone cable and a second end coupled electrically to the mobile communication network.

This application claims the benefit of the Taiwan Patent Application Serial NO. 098110086, filed on Mar. 27, 2009, the subject matter of which is incorporated herein by reference.

### BACKGROUND OF THE INVENTION

1. Field of the Invention

The present invention relates to a base station, more particularly to a simple base station, which is adapted to be coupled to a mobile communication network via a telephone cable.

2. Description of the Prior Art

Since portable communication comes into being, the wireless communication plays an important role in our daily life. In order to maintain the proper wireless communication of a mobile phone or a notebook computer for wirelessly coupled to the Internet, the telecommunication companies have set up a plurality of base stations to assist the wireless communication.

Since each base station can encompass a limited range, the base stations are built up densely in order each of the mobile phone to receive or transmit the communication signals properly. Therefore, within a dwelling community, several LANs (Local Area Network) may be installed. To be more specific, in downtown area of a city, setting up the base station for smooth signal communication among the mobile phones results in extra expense and labor waste.

Moreover, it is difficult to set up relatively large type base station in ancient sites, remote places so that in case one man uses his mobile phone in such places, he may find it hard to receive the communication signals or encounter weak communication. Under this condition, the land-cabled telephone is the source he can rely on.

Since it is relatively hard to setup large type base stations in the ancient sites or remote places and since it is not compatible to the economy, the wireless communication problems in those areas are not improved and are not taken care of.

Therefore, the main object of the present invention is to provide a simple base station, which is adapted to be coupled to a mobile communication network via a telephone cable so as to improve the aforesaid drawbacks.

### SUMMARY OF THE INVENTION

The object of the present invention is to provide a simple base station, which is adapted to be coupled to a mobile communication network via a telephone cable.

The simple base station of the present invention is adapted to be coupled to a mobile communication network via a telephone cable, and includes an antenna module, a transmission control module, a converting module and a modem.

The antenna module is capable of receiving and transmitting a plurality of frequency signals and later transmits the frequency signals to the converting module.

The transmission control module sets up a plurality communication channels respectively corresponding to the plurality of frequency signals. A communicated channel is defined for the frequency signals of a predetermined range.

The converting module has the function of converting a respective one of the frequency signals within a respective one of the communication channels into a packet and transmitting the packet to the modem.

The modem has a first end coupled electrically to the Internet via the telephone cable and a second end coupled electrically to the mobile communication network. After converting the packet into an analog signal, the modem transmits the analog signal to the Internet, which, in turn, transmits the analog signal to the mobile communication network, thereby establishing a communication between the simple base station and the mobile communication network.

Therefore, by installing the simple base station of the present invention to a site, where cabled telephone set is available, the user can be coupled to the mobile communication network, thereby providing a larger wireless communication range. Because the simple base station of the present invention is compact in size and is easy to install, it can be easily installed at the ancient sites or remote places, where a cabled telephone set is already available.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 illustrates a diagram representing a simple base station of the present invention;

FIG. 2 is a diagram representing the simple base station of the present invention transmitting a signal therefrom; and

FIG. 3 is a diagram representing the simple base station of the present invention receiving a signal.

### DETAILED DESCRIPTION OF THE PREFERRED EMBODIMENT

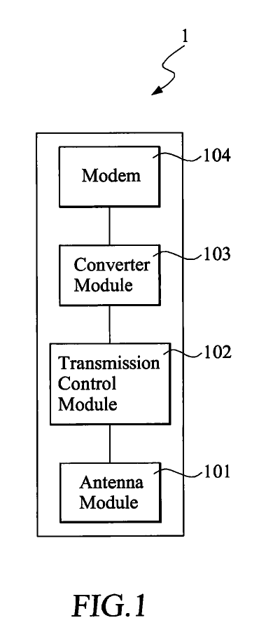

FIG. 1 illustrates a diagram representing a simple base station of the present invention. As shown, the simple base station 1 of the present invention includes an antenna module 101, a transmission control module 102, a converting module 103 and a modem 104.

The antenna module 101 is coupled electrically to the transmission control module 102 and is used for receiving a radio frequency signal and transmitting the radio frequency signal to the transmission control module 102. The antenna module 101 is also capable of transmitting the received radio frequency signal to a far away distal end.

The transmission control module 102 has one end coupled electrically to the antenna module 101 and the other end coupled electrically to the converting module 103. The received frequency signal is transmitted to the converting module 103 via the transmission control module 102. The transmission control module 102 sets up a plurality communication channels such that when the antenna module receives a radio frequency signal, the transmission control module 102 sets up a respective communication channel for passage of the frequency signal from an initial source. In case, the antenna module 101 receives a second frequency signal from a different source, the transmission control module 102 will allocate a second communication channel for transmitting the second frequency signal to the converting module 103. Since the transmission control module 102 can allocate a plurality of independent communication channels, the frequency signals of different range are transmitted to the converting module 103 free from interference or without being interrupted relative to each other so that there is no data loss at the receiving end to permit smooth operation of the initial performance.

The communication channels set up within the transmission control module 102 transmit the radio frequency signals by time division multiplexing (TDM). Alternately, the communication channels transmit the radio frequency signals by frequency division multiplexing (FDM).

The converting module 103 is coupled electrically to the modem 104, and has the function of converting a respective one of the frequency signals of the corresponding communication channel into a data packet and transmitting the packet to the modem 104. Additionally, the converting module 103 further has the function of converting the packet into a radio frequency signal, which can be transmitted to the antenna module 101 for transmitting therefrom.

The modem 104 has the function of converting the data packet into an analog signal and vice versa. The modem 104 has a first end coupled electrically to the converting module 103 and a second end coupled electrically to the telephone cable for transmitting the analog signal to the distal end.

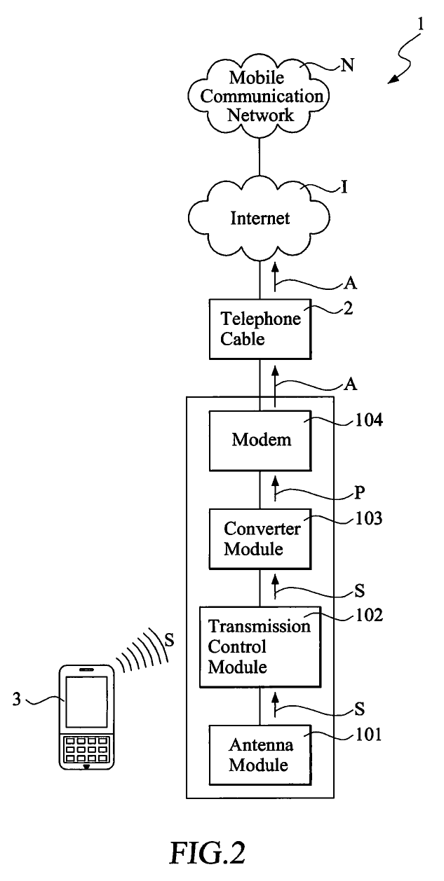

FIG. 2 is a diagram representing the simple base station 1 of the present invention transmitting a signal therefrom.

As illustrated, the mobile phone 3 transmits a frequency signal S to the simple base station 1 of the present invention, which is coupled electrically to the telephone cable 2. The telephone cable 2 is coupled electrically to the Internet I and the mobile communication network N.

The frequency signal S radiated by the mobile phone may include digital data. The antenna module 101 will, upon receipt of the frequency signal S, transmit the frequency signal S to the converting module 103 via the transmission control module 102. The converting module 103 converts the frequency signal S into a data packet P and transmits the packet P to the modem 104, which, in turn, converts the packet P into the corresponding analog signal A. The analog signal A is transmitted via the telephone cable 2 to the Internet I, which analyzes the analog signal in order to obtain the digital data. At this time, the Internet I being coupled to the mobile communication network N, and the mobile phone 3 being communicated with the communication network N, the digital data is transmitted to the distal end.

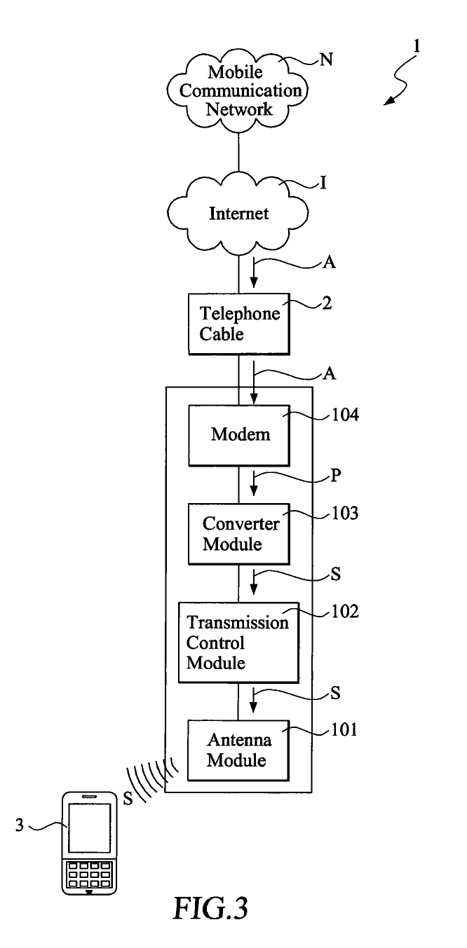

FIG. 3 is a diagram representing the simple base station of the present invention receiving a signal. In case, a digital data is transmitted from the distal end to the mobile phone 3, the digital data is conveyed to the Internet I via the mobile communication network N. At this time, the Internet I will analyze the digital data and converts the same into the analog signal A, which is transmitted via the telephone cable 2 to the modem 104. Upon receipt of the analog signal A, the modem 104 converts the analog signal A into the packet P and is transmitted to the converting module 103, where, the converting module 103 converts the packet P into the transmitting signal S. The transmitting signal S is passed to the antenna module 101 via the transmission control module 102 such that the antenna module 101 radiates the transmitting signal S to the mobile phone 3. Under this condition, the mobile phone 3 is capable of receiving the digital data transmitted from the distal end.

Therefore, by utilizing the simple base station of the present invention, the mobile phone can be coupled to the mobile communication network even though there is no large size base station available at the site where the mobile phone is operated.

It is relatively easy to install the simple base station of the present invention. So long as there is a telephone cable, the present simple base station can be installed, thereby providing a relatively large communication range. In those remote places, where setting up large type base station is not compatible to the economy and where conventional telephone cable is available, the present simple base station can be easily setup in order to increase the communication range of the mobile phone.

Since only a relatively small room is required to install the simple base station of the present invention, a relatively large amount of repairing and maintenance fee can be economized when one uses the simple base station of the present invention.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A base station for coupling to a mobile communication network via a telephone cable, comprising:
an antenna module for receiving and transmitting a plurality of radio frequency signals;
a transmission control module for setting up a plurality communication channels respectively corresponding to said radio frequency signals;
a converting module coupled electrically to said transmission control module for converting each of said radio frequency signals of said corresponding communication channel into a packet; and
a modem for coupling at one end to Internet via a telephone cable in order to couple to the mobile communication network, and for electrically coupling at another end to the converting module.

2. The base station according to claim 1, wherein the Internet is coupled electrically to the mobile communication network.

3. The base station according to claim 1, wherein said communication channels transmit the radio frequency signals by time division multiplexing (TDM).

4. The base station according to claim 1, wherein said communication channels transmit the radio frequency signals by frequency division multiplexing (FDM).

5. The base station according to claim 1, wherein said converting module has a function of receiving another packet and converting said another packet into a radio frequency signal.

6. The base station according to claim 1, wherein said modem has a function of receiving another packet and converting said another packet into an analog signal.

7. The base station according to claim 1, wherein said modem has a function of receiving an analog signal and converting said analog signal into a packet.
